(19) United States
(12) Patent Application Publication
(10) Pub. No.: US 2011/0042019 A1
(43) Pub. Date: Feb. 24, 2011

(54) SELF-LOCKING SLAT FOR SHUTTER

(76) Inventors: Luis Francisco Asensi Alonso, Valencia (ES); MaCarmen Borderia Monterde, Valencia (ES)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/989,322

(22) PCT Filed: Apr. 13, 2009
(86) PCT No.: PCT/ES2009/070098

§ 371 Date: Oct. 22, 2010

(30) Foreign Application Priority Data
Apr. 14, 2008 (ES) P200801053

(51) Int. Cl. E06B 9/15

(52) U.S. Cl. 160/236

(57) ABSTRACT

The present invention relates to a self-locking slat for shutter, which has been specially designed to lock the shutter before attempts to open it from the exterior. The ends of the self-locking slat can be inserted into a coupling element, while the sides of the slat and of the coupling element between slats can be positioned inside side shutter guides, such that, the ends of the slat can rotate in relation to the ends of the coupling element. The slat object of the invention is characterized in that it at least includes a locking projection which becomes locked in the guide and at least one of its ends matches a cavity for engaging the end of the coupling element.

### CROSS-REFERENCE TO RELATED APPLICATIONS

This application is a National Stage of International Application No. PCT/ES2009/070098, filed Apr. 13, 2009. This application claims the benefit and priority of Spanish Application No. 200801053, filed Apr. 14, 2008. The entire disclosure of each of the above applications is incorporated herein by reference.

### OBJECT OF THE INVENTION

The present invention relates to a self-locking slat for shutter, which has been specially designed to lock the shutter before attempts to open it from the exterior.

The ends of the self-locking slat can be inserted into a coupling element, while the sides of the slat and of the coupling element between slats can be positioned inside side shutter guides, such that, the ends of the slat can rotate in relation to the ends of the coupling element.

The slat object of the invention is characterized in that it at least includes a locking projection which becomes locked in the guide and at least one cavity for engaging the end of the coupling element.

### BACKGROUND OF THE INVENTION

As is known, there are various types of self-locking shutters, which utilize slats and coupling elements constituting mechanisms that prevent the shutter from being opened from the exterior.

The slat object of the invention performs a more efficient lock, because it is achieved by at least one locking projection with means for engaging the connecting element.

In the completely closed position of the shutter, the folded-out slats are in contact with the guides and the rocking motions of the shutter against the guide caused by the air and the external vibrations with the drawbacks of noise and deterioration of the same, are eliminated. By being inserted into the guide profiles making up a solid panel, a noticeable increase in the resistance to severe weather conditions such as a storm is obtained.

In the state of the art several shutters are known, which somehow seek to lock when are lifted, cooperating elements should be used in blocking. Such documents are the Spanish utility model ES 1051848U, and German patent DE 929213C.

### DESCRIPTION OF THE INVENTION

The present invention relates to a self-locking slat for shutter, which has been specially designed to lock the shutter before attempts to open it from the exterior.

The ends of the self-locking slat can be inserted into a coupling element, i.e. connecting elements usually located above and bellow the slat. The sides both of the slat and coupling element between slats can be positioned inside side shutter guides, such that, when an attempt is made to open the shutter from the exterior the ends of the slat can rotate in relation to the ends of the coupling elements.

The slat object of the invention is characterized in that it at least comprises a locking projection which becomes locked in the guide and at least one of its ends matches a cavity for engaging the end of the coupling element.

According to the aforementioned, the slats facilitate the self-locking by leaving the verticality due to the relative rotation between its ends and the coupling element, thus producing the wedging in the guide.

When lowering or lifting the shutter there is no force acting from the lower zone, slats and coupling elements are coupled at their vertical position and have no contact with the profiles of the side guides, which allows upward, folding, downward, folding-out without side contacts motions to be carried out.

The use of the described slats can make up the whole shutter or sections thereof, by being adapted to shutters already installed, which do not have self-locking features.

### DESCRIPTION OF THE DRAWINGS

The present specification is complemented with some planes for illustrating and not limiting the preferred example of the invention.

FIG. 1 is a schematic view of a vertical section of an embodiment of one slat.

FIG. 2 is a schematic view of a vertical section of an embodiment representing the self-locking position between the coupling element and the slat according to FIG. 1.

### PREFERRED EMBODIMENT OF THE INVENTION

The ends (1.4, 1.3) of the slats (1) can be inserted into the corresponding coupling elements (2). Their sides, both of the slat (1) and of the coupling element (2) are inserted into a shutter guide (3), see FIG. 2.

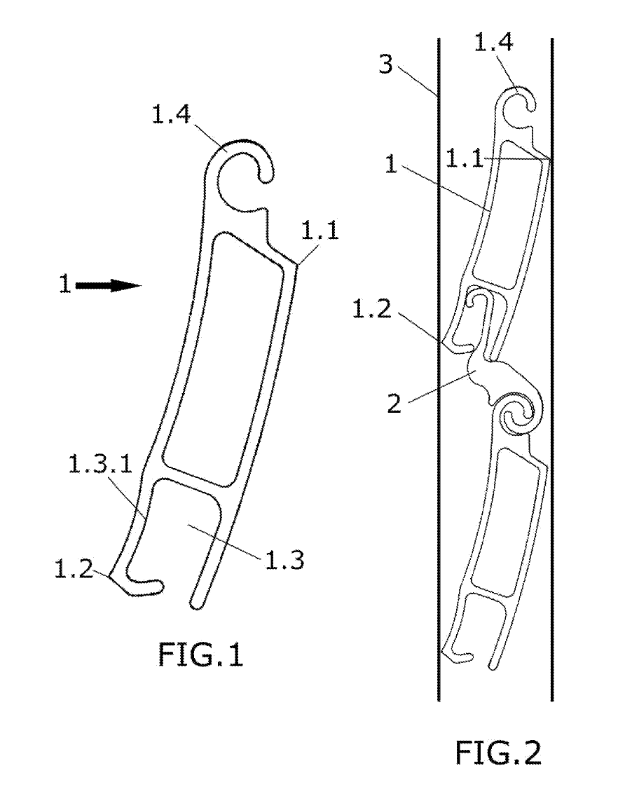

In FIG. 1, the slat (1) includes a first upper locking projection (1.1) which becomes locked in the guide (3) at one of its faces together with a second lower locking projection (1.2) which becomes locked in the guide (3) at the face opposed to the first projection (1.1).

The lower end (1.3) of the slat (1) shown in the embodiment is materialized in a lower cavity for engaging an end of the coupling element (2).

With the object of facilitating the rotation between the slat (1) and the coupling element (2), the inner face (1.3.1) of the lower cavity (1.3) is convex, even though it could also be straight.

1. Self-locking slat for shutter, ends (1.3, 1.4) of which can be inserted into corresponding coupling elements (2) and sides of which can be positioned inside a shutter guide (3), such that, the ends (1.3, 1.4) of the slat (1) can rotate in relation to the ends of the coupling elements (2), characterized in that the slat (1) includes at least a projection (1.1) and a second projection (1.2) which become locked to lock in the guide (3) and wherein the locking projection (1.2) is arranged on the end and al least one of its ends (1.3) and at the face opposed to the first projection (1.1) and wherein the end (1.3) also includes corresponds with a cavity for lineally engaging an end of the coupling element (2), the inner face (1.3.1) of the cavity being convex and wherein on the lower end (1.3) there is a cavity inwardly projecting towards the inside of the slat.

2. (canceled)

3. (canceled)

4. (canceled)
